(19) United States
(12) Patent Application Publication
(10) Pub. No.: US 2002/0198764 A1
(43) Pub. Date: Dec. 26, 2002

(54) On-line evaluating and marketing system and method

(76) Inventors: Dean L. Schorno, Burlingame, CA (US); Elan D. Scheinman, Redwood City, CA (US)

Correspondence Address: SKJERVEN MORRILL LLP, 25 METRO DRIVE, SUITE 700, SAN JOSE, CA, 95110, US

(21) Appl. No.: 09/891,734

(22) Filed: Jun. 26, 2001

(51) Int. Cl. G06F 17/60

(52) U.S. Cl. 705/10

(57) ABSTRACT

A system and method for viewing, analyzing, and marketing an object over the Internet is provided. An object is scanned using computer tomography (CT) to produce scan data that includes density distribution information and can be used to understand the internal composition of the object. Using a reconstruction technique, scan data is reconstructed to render images of the scanned object. The reconstructed images are individually selected or grouped to provide one or more marketing presentations that include information about various internal features of the scanned object. The marketing presentations are made available for viewing on an Internet web site. The web site includes interactive tools. A user may use different user interface devices to cause the system to display various aspects of the object, evaluate the object, or to calculate an optimal cut solution for the object.

### BACKGROUND

1. Field of the Invention

This invention relates to the field of computer software and, more particularly, to a system and method for automated grading, marketing, and analyzing logs and lumber over the Internet.

Certain features of the system and method described herein may be implemented by one skilled in the art using a suitable computer programming language in form of software that includes one or more computer programs or modules.

### TRADEMARK AND COPYRIGHT NOTICE

A portion of the disclosure of this patent document contains material, which is subject to copyright protection. The owner has no objection to the facsimile reproduction by any one of the patent document or the patent disclosure, as it appears in the Patent arid Trademark Office patent file or records, but otherwise reserves all copyrights whatsoever.

Certain marks referenced herein may be registered trademarks of third parties affiliated or unaffiliated with the applicant or the assignee. Use of these marks is for the purpose of providing an enabling disclosure by way of example and shall not be construed to limit the scope of this invention to material strictly associated with such marks. By referring to such marks, neither the applicant nor the assignee intends to claim ownership or association with such marks.

2. Related Art

Sawmills and wood-product manufacturers, typically, purchase logs from log dealers and distributors. Since the value of a log is dependent on the nature and extent of defects in the log, log purchasers typically employ experts to evaluate logs prior to purchase. The conventional evaluation methods require the physical inspection of the exterior of the log (e.g., protruding branches) in an effort to predict cracks, voids, decay, knots, and other non-visible features of the log. An expert based on past experience and knowledge of growth patterns in a tree attempts to estimate and determine the hidden defects in a log, grade the log, and estimate the value of the log.

With the advent of the Internet and related computerized technology, on-line purchase models have been implemented that provide convenient methods and forums for sale and delivery of various products. Unfortunately, however, there are no on-line models dedicated to evaluating and marketing logs using technology that provides cutting and processing solutions to a purchaser. Appendix A includes screen printouts of a business to business on-line auction model (e.g., e-wood.com) that among other items provides lumber for sale. As illustrated in FIG. A1, a number of items are listed for sale in conjunction with an initial bidding price and a date reflecting the close of auction for each listed item. Selecting a link associated with each listed item displays additional information about that item.

For example, as illustrated in FIGS. A1 and A2, activating the link “Maple Boxes, ¾×7¼″ displays a color image of a box of wooden boards at bid price of $187.00. Other information, such as time remaining to the closing of auction, board measurements, and other particulars are also displayed. The displayed images are not the actual images of the specific wooden boards for sale, but images of representative boards selected for photography and display on the web site. Further, not all listed items include images. Referring to FIG. A3, for example, some links only include information about measurements of the item. In either scenario, a potential purchaser has to primarily rely on the text included in the web site to discern the characteristics of the item.

Other Internet sales models for the sale of lumber are available on the World Wide Web that provides images of the actual product. For example, “Veneerrnet.com” is a web site that includes listings of veneer products along with their images, and measurements. However, the user does not have access to any tools that would allow him to select a certain view of the boards or logs listed for sale, or to determine a specific cutting or processing solution based on analyzing the internal features of the item.

The above marketing methods and sales models fail to provide a user with a chance to evaluate and analyze the sale item by reviewing the internal features of the object or by selecting specific views of the object. As such, a potential purchaser cannot determine with a degree of certainty whether a log or other product offered for sale can be used for a specific purpose. Even an expert, would be unable to accurately discern the extent of defects in the log or boards offered for sale, merely based on the information provided on the site.

Unfortunately, no on-line methods are available that provide a purchaser with sufficient information to properly evaluate and analyze a log, lumber, or other item offered for sale. Even though purchasing a log, lumber, or other item over the Internet would be more convenient than the traditional purchasing methods, a potential purchaser typically cannot discern sufficient information about the quality of the item or log to make an intelligent purchase. The purchaser has no means to inspect the sales item for damage or defects. Further, there are no means to allow the purchaser to determine whether the item is fit for the intended purpose. For example, it would be very difficult for a log purchaser to determine if a specific cutting strategy for a log would yield satisfactory results (e.g., produce a certain number and grade of boards), if the only information provided about the log includes the log's measurements or images of the log's exterior surface.

Due to the above shortcomings, the prior art on-line models are not effective and productive tools for evaluating, analyzing, and marketing logs. An on-line model that can provide a purchaser with sufficient information about both the external and internal features of a log, or lumber is highly desirable.

### SUMMARY

A system and method for viewing, analyzing, and marketing an object using current technological advancements in the fields of interactive computer software and the Internet is described. In one or more embodiments of the invention, an object such as a log is scanned using special scanning technology such as computer tomography (CT) to produce scan data. Scan data includes density distribution information that can be used to understand the internal composition of the object. Using a reconstruction technique, scan data is reconstructed to render images of the scanned object. The reconstructed images are individually selected or grouped to provide one or more marketing presentations that include information about various features of the scanned object.

In accordance with an aspect of the invention, the marketing presentations are made available for viewing on an Internet web site, for example, by a service provider. The web site includes interactive tools that allow a system user to navigate through the site and use the services provided by the system. A user may use different user interface devices to cause the system to display various aspects of the object. These various aspects are pre-selected and are displayed in the form of perspective views, cross-sectional views, or a moving picture displaying certain aspects of the object. In some embodiments, a system user may utilize special software to filly access the scan data for an object presented on the system. Using the special software, a user can view the internal features of the object by selecting, in real time, specific cross-sections of the object for viewing. Furthermore, the user can use the software to produce custom virtual images of the object in different perspective views and orientations.

The invention in certain embodiments is configured to evaluate, analyze, and market logs and lumber. In such embodiments, scan data is used to grade the log based on National Hardwood Lumber Association (NHLA) grading standards or other well-known standards in the industry. In some embodiments logs are graded based on user specified input and custom grading standards. The grade of a log is determined by the type and nature of defects in the log and the frequency in which defects appear through out the body of the log. In one or more embodiments, the system automatically grades and evaluates a log based on the log's internal features (e.g., decay, voids, and knots). Based on this assessment, the system also automatically calculates an optimal cut solution for the log to maximize the value and quality of boards produced from sawing the log. In some embodiments, the optimal solution is determined based on parameters entered by the user that define the length, thickness, width, and other attributes of the boards that are to be produced from the log.

Embodiments of the invention provide a user with the option to experimentally simulate a cut pattern on a selected log allowing the user to only view the exterior of the log. Afterwards, the system determines an optimal sawing strategy based on information available from the scan data about the internal features of the log. The system then compares the result of the optimal sawing strategy with the result of the cut pattern selected by the user. The system then evaluates each result and reports the difference in terms of the number, quality, and size of boards produced. The report, in addition to including information indicative of the most cost effective and economically efficient sawing strategy, provides the user with cutting tips so that the user can improve his technical skills in sawing, grading, and evaluating logs.

### BRIEF DESCRIPTION OF THE DRAWINGS

FIG. 1 illustrates a computer network environment in accordance with one aspect of the invention including a server system and a client computer.

FIG. 2A is a block diagram of one embodiment of the server system or client computer of FIG. 1.

FIG. 2B is a block diagram of software that directs the operation of the computer system illustrated in FIG. 2A.

FIG. 3 is a flow diagram of a method of marketing an object in accordance with an aspect of the invention.

FIG. 4 is a flow diagram of an on-line method of evaluating and purchasing a log, according to one or more embodiments of the invention.

FIG. 5 is an example of a graphical menu interface implemented to allow a user to access various features of the system, in accordance with one or more aspects of the invention.

FIG. 6 is an example of a graphical user interface, in accordance with one or more embodiments of the system, providing a user with information about an object.

FIG. 7 is an example of another graphical user interface, in accordance with one or more embodiments of the system, providing a user with images of different cross-sections of a log.

FIG. 8 illustrates an example of virtual board faces in association with the number and value of boards that may be produced using a conventional sawing method, in accordance with one or more embodiments of the system.

FIG. 9 illustrates an example of virtual board faces in association with the number and value of boards that may be produced using a system-recommended sawing method, in accordance with one or more embodiments of the system

FIG. 10 illustrates a computer network environment including a server system and client computers attached to scanning and sawing systems in accordance with one aspect of the invention.

FIG. 11 illustrates a flow diagram for a method of formatting and transmitting requested image data from a server system to a client computer, in accordance with one embodiment of the invention.

### DETAILED DESCRIPTION OF THE PREFERRED EMBODIMENTS

The invention is directed to a method and system for evaluating, analyzing, and marketing an object by displaying images of the object that include information about the internal features of the object. Embodiments of the invention are described by way of example as applicable to an on-line system. In accordance with one embodiment, the on-line system provides services for evaluating and analyzing logs in a non-destructive manner. This evaluation is based on data acquired by using computer tomography (CT) technology to scan the logs.

The examples provided herein, however, are provided to illustrate the invention in more detail and are not to be construed to limit the application of the invention to logs or CT technology only. One skilled in the art would appreciate that the scope and application of the invention is more comprehensive than that described in relation to the included examples. In alternative embodiments, the invention may be directed to evaluating, analyzing, or marketing any object (e.g., agricultural produce, art pieces, diamonds, etc.), using any scanning technology (e.g., ultrasound, laser, MRI, etc.). Certain embodiments of the invention may utilize Internet or other media for marketing the object in a worldwide or a local network.

The on-line system and services of this invention are managed, maintained, and operated by a service provider, in accordance with one aspect of the invention. The service provider is an entity that provides the services of the system on an accessible network. In one or more embodiments, a user needs to subscribe to the service provider to use the services provided by the system.

In the following, numerous specific details are set forth to provide a thorough description of various embodiments of the invention. It is apparent, however, to one skilled in the art that certain embodiments of the invention may be practiced without these specific details or with some variations in detail. In some instances, well-known features not pertinent to the novelty of the system are described in less detail so as not to obscure the more relevant aspects of the invention.

System Architecture

In one or more embodiments, a computer architecture is utilized to provide the on-line marketing services of the system and to manage data communications between the user and the service provider. Typically, a computer's architecture is composed of two distinct environments, a software environment and a hardware environment. The hardware environment, as it is discussed in further detail below, includes the machinery and equipment that provide an execution environment for the software. On the other hand, the software provides the execution instructions for the hardware.

In operation, a computer needs both the hardware and software environments to function. The software environment can be divided into two major classes including system software and application software. System software includes control programs, such as the operating system (OS) and information management systems that control how the hardware functions and processes information. An example of system software is Microsoft Windows 2000® operating system.

Application software is a program that more directly interacts with a user or other data source and processes specific information provided by the user or data source. The hardware environment specifies the instruction set, and the software environment provides the instructions for the hardware to execute. With the current advances in technology, computing systems are designed so that many functions can be interchangeably implemented in hardware or software environments.

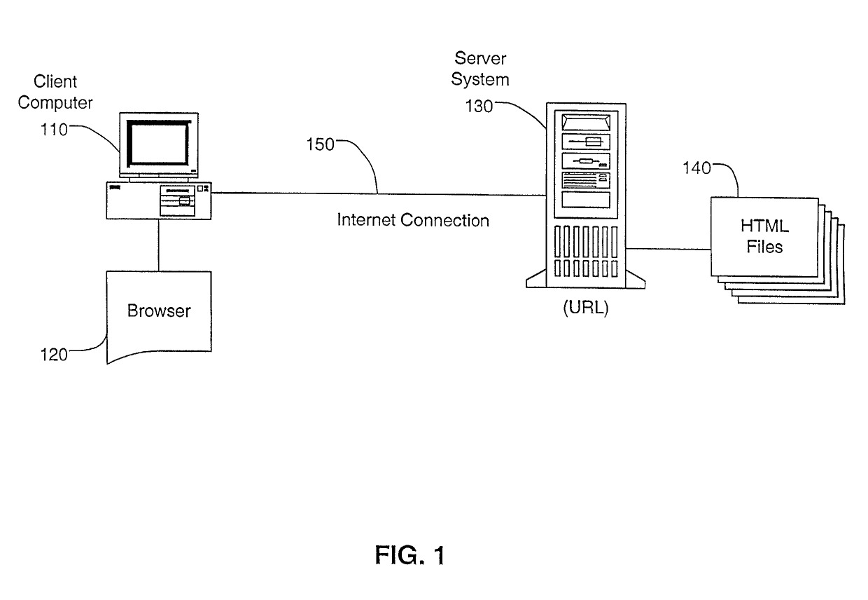

FIG. 1 illustrates the system architecture of this invention in accordance with one or more embodiments, where a user communicates with server system 130 via Internet connection 150 using a client computer 110. The system's connection to the Internet allows global on-line access to the services provided by the system. It should be noted however that embodiments of the invention need not be connected to the Internet and may operate in a local area network (LAN) or an independent stand-alone environment.

The system software and the application software that implement the on-line services are at least partially installed on one or more server systems, such as server system 130. In accordance with one aspect of the invention, the on-line services are available to entities that have established an account with the service provider. Internet connection 150 connects client computer 110 to service provider's server system 130. Computer 110 is utilized by a user to access information available through server system 130 and to view various aspects of an object presented or offered for sale.

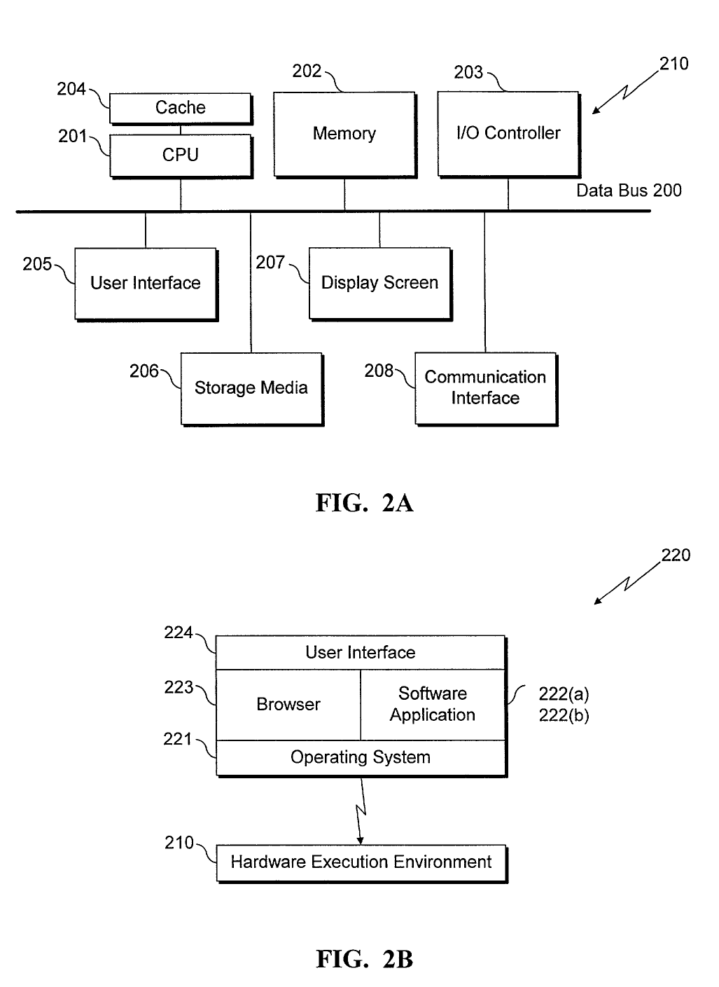

Client and server computer systems 110 and 130 include hardware and software components and system architectures suited for operation of application software 222 of this system. This system, including the application software 222 for marketing and analyzing an object is implemented in association with hardware system 110 (FIG. 2A) and software system 220 (FIG. 2B) as described in further detail below.

The following hardware and software components of the above client and server architectures as illustrated in FIGS. 2A and 2B are provided by way of example. The invention may be practiced either individually or in combination with other suitable hardware or software architectures or environments.

Application Software for Analyzing and Marketing an Object

Referring to FIGS. 1, 2A, and 2B, in accordance with one or more aspects of the system, a user can use computer equipment, such as computer 110, to evaluate and purchase an item utilizing application software 222. Application software 222 is configured to present different views and images of an item to a user and process any sales transactions that may arise as a result of a user's request to purchase the item.

Computer 110 can be a stand-alone system, or as illustrated in FIG. 1 a system connected to service provider's server system 130 via Internet connection 150 in a worldwide network. Alternatively, client computer 110 and server system 130 may be connected in a local area network. As it is described in more detail below, application software 222 can be executed partly or fully on server system 130 or client computer 110 depending on system implementation. In a stand-alone environment, computer 110 handles the majority of data management and communication.

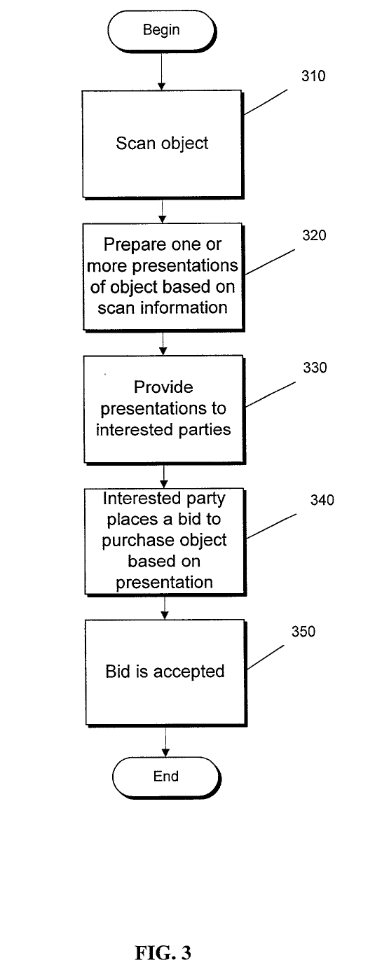

FIG. 3 illustrates a flow diagram of a method of marketing an object, in accordance with one or more aspects of the system. In accordance with certain aspects of the invention, the steps illustrated in FIG. 3 are implemented in form of computer readable code configured for execution on a general-purpose computer, such as computer 110.

At step 310, an object is scanned by a scanning device to produce scan data that includes information about the internal composition of the object. The scan data can be evaluated to reconstruct image of external and internal features of the object. Scanning technologies such as computerized tomography (CT), ultra sound, laser, magnetic resonance imaging (MRI) and other technologies that allow nondestructive data acquisition over the volume of an object may be used to scan the object.

At step 320, one or more presentations for marketing, evaluating, and analyzing the scanned object are prepared using scan data acquired from scanning the object. As described further below, the presentations can include still or moving images of the scanned object or data structures that describe the defect and/or grain pattern in the log. In some embodiments, the images include perspective or cross-sectional views of the object. In addition, the presentations can also include information about the size, shape, weight, or other attributes of the object.

In certain embodiments, the system evaluates the object's characteristics and assigns a value to the object based on those characteristics in accordance with a rating standard or evaluation model for that kind of object. For example, if the object is a log, the system determines the number, location, and type of defects in the log. Based on this information and applicable log grading standards, the system assigns a grade and value to the log. The assigned grade and value are associated with the quality of the log.

At step 330, the presentations are provided for viewing or use by interested parties (e.g., potential purchasers of the item), on a publicly accessible network. In some embodiments, the presentations are broadcast over the Internet or other broadcasting networks such as television to potential purchasers. In some embodiments, a potential purchaser can request to view the presentations by interacting with the system as further described below. In one or more embodiments, parties can choose various viewing options to view the presentations that include pre-selected views of the object.

In some embodiments, an interested party or a potential purchaser may utilize special software that allows him or her to fully access the scan data that is typically stored on server system 130 or other remote server. Using the special software, a purchaser may reconstruct three-dimensional views of various portions of the object, rotate the object about multiple axes, and select to view the internal features of the object from different angles and cross-sections in real time.

A user can assess the internal features of an object and fully evaluate the object for his or her special needs, using the various viewing features of the system. For example, if the object is a log, the purchaser can view the defects (e.g., decay, voids, knots, etc.) within the log. Having access to full scan data also allows a purchaser to simulate sample cuts through various cross-sections of the log and have the system analyze the scan data to determine whether the log can be optimally utilized for a specific purpose.

For example, a sawmill may require boards with two side clear faces (e.g., without any knots or other defects) that are 8 feet long, 8 inches wide, and 3 inches thick. Currently, a sawmill cannot determine with certainty that a board meeting these requirements will be created from a given log. Using the evaluation and processing tools provided by the system, a user can determine whether a certain log can be cut to satisfy specific user requirements, prior to purchasing or sawing the log.

Once the purchaser evaluates the scanned object based on the above marketing presentations, at step 340, the purchaser places an order or a bid to purchase or transfer the scanned object. At step 350, the bid, purchase offer, or transfer transaction is accepted and processed. In embodiments of the system, more than one object may be presented for sale and thus the system displays a list including the available objects for viewing by potential purchasers. A potential purchaser then has the option to select any of the listed items and further learn about the item in detail by viewing one or more of the pre-constructed marketing presentations stored on the system for that item. In other embodiments, rather than manually searching through the list to find a suitable item, the user can enter information about the item that best suits his or her needs.

The system, in one or more embodiments, evaluates the available items to determine if any of the listed items satisfies the user's request based on the information provided. For example, the user may be looking for a log that can produce one hundred board feet of five-foot long, three-by-four Maple boards with no knots. Once the user has provided the information, the system analyzes scan data for each Maple log listed for sale to determine whether a certain cutting solution for a certain log can produce the boards that satisfy the submitted request. If any of the logs listed can satisfy the user's needs then the user is notified and is given the option to further research the log using system's viewing utilities or place an order to purchase the log. System provided tools and options for evaluating, processing, and marketing logs are described in further detail below.

The system in certain embodiments is configured to process multiple purchase offers using well-known commercial sales models. For example, in one embodiment, multiple purchase offers are handled in accordance with a forward auction model (e.g., the items are sold to the highest bidders until no more bidders or no more sale items are left). In another embodiment, a reverse auction model is utilized that allows a user to submit a price for which he would be willing to purchase an item with particular features. If the system finds such an item, at the requested price, the sales transaction is completed. Other sales models such as an exchange model may also be implemented where multiple parties bid on or offer multiple items for sale.

The various features of the system will be better understood after reviewing an illustrative example of the invention as applicable to a method for evaluating and marketing logs over the Internet. This example is presented to describe the invention in further detail, but is not meant to limit the scope of the invention.

Evaluating, Analyzing, and Marketing Logs Over the Internet

The current invention in one or more embodiments is implemented to take advantage of the functionality provided by computer networks and the Internet to market, evaluate, and process logs on the Internet. The following includes a discussion of how computers and various resources available on the Internet interact to implement the system of the current invention.

FIG. 1 illustrates a computer network, in accordance with one or more embodiments of the invention, wherein client computer 110 communicates with server system 130 via Internet connection 150. A computer network includes a group of computers and other computing devices linked together in a manner that promotes communication between them. The Internet is a global computer network that provides the infrastructure for the World Wide Web, a communication system that is composed of millions of files that contain links to other files stored on various connected computer networks.

In one or more embodiments of the invention, server system 130 (also known as a host computer) stores and manages information acquired from scanning logs. This information is stored in one or more databases. A user may use computer 110 (also known as a client computer) to access the information stored in the one or more databases to evaluate and purchase a log. Client computer 110 accesses server system 130 via an Internet service provider. An Internet service provider is an entity that provides connectivity to the Internet via analog telephone lines, Integrated Services Digital Network (ISDN) lines, optical cables, or other communication media. Client computer 110 and server 130 communicate over the Internet using a set of rules referred to as communication protocols.

Communication protocols are established set of standards that dictate the manner in which information is communicated in a network. In accordance with these standards, electronic information is coded (i.e., packetized), addressed, routed, delivered, and tracked to ensure delivery to the proper destination. Once received at the destination, the information is decoded (i.e., depacketized) by the receiving computer. Hypertext Transport Protocol (HTTP) is the current standard protocol for communicating with an information server on the Internet.

As illustrated in FIG. 1, a browser 120 that runs on client computer 110 allows a user to access information on server system 130 via Internet connection 150. A browser is a commonly used tool for communication over the Internet. Examples of popular browsers that are currently available include Netscape Navigator, Microsoft Internet Explorer, Mosaic and Cello. Browser 120 provides a user-friendly environment in which a user can interact with computer 110 via a graphical user interface (GUI). A GUI allows the user to submit various requests or responses without having to learn or type complicated or unmemorable text commands. Browser 120 provides means for requesting, transferring, and displaying information that is stored as files on server system 130 or other connected servers on the Internet.

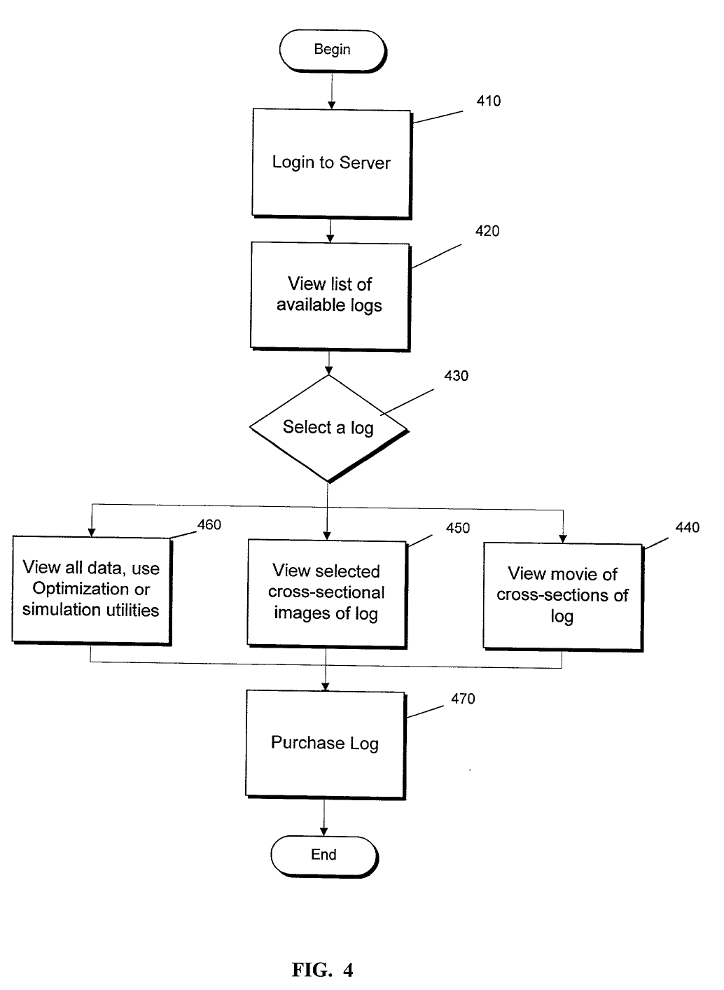

FIG. 4 is a flow diagram of a method of evaluating and purchasing a log, in accordance with one or more aspects of the invention. At step 410, a log purchaser (i.e., a system user) utilizes client computer 110 to login to server system 130. To login, computer 110 transmits a request to establish a connection with server system 130. Server system 130 responds to client computer 110's request by forwarding a response requesting the user's identification and password, for example. In certain embodiments, the login process may be unnecessary or may be required on a onetime basis so that the user's name and information can be registered and collected for future communication.

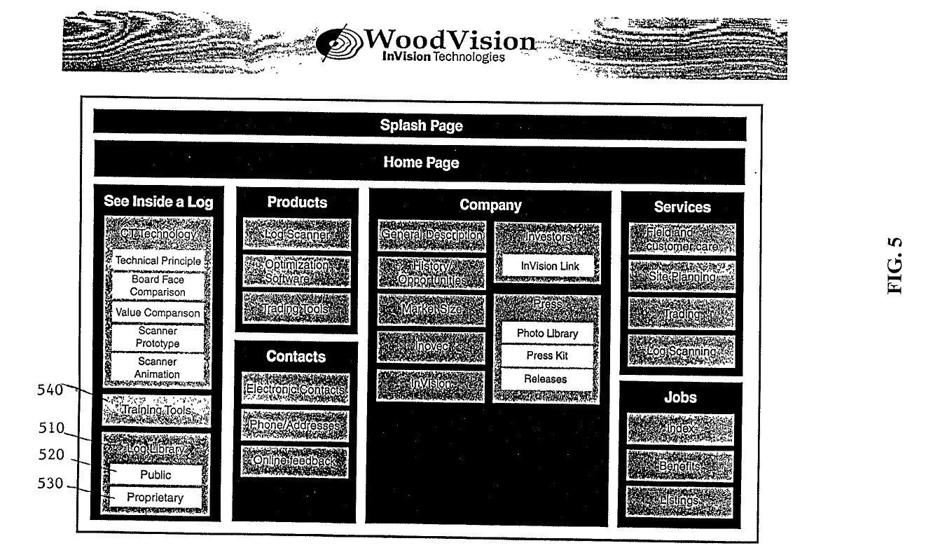

In embodiments of the invention, after connection between computer 110 and server system 130 is established, the user may access the service provider's web site on server 130. A web site is a collection of linked web pages. Web pages are interactive resources stored on server system 130, for example, that provide a user with a graphical interface for viewing information or using a service. FIG. 5 illustrates an example of a web page, in accordance with one or more embodiments of the system that includes an interactive menu containing links that give the user access to services provided by the system.

To access the web site for the system, a user enters the Uniform Resource Locator (URL) for the web site (e.g., “WoodVision.com”) in the appropriate address box on the browser. A URL is a standard addressing scheme in form of a string of characters. Associated with the URL is information indicating the location of a resource (e.g., a web page) on the Internet, type of service requested, and method (i.e., protocol) of communicating with that resource.

The browser submits the URL information in a request (e.g., GET “http://www.woodvision.com/homepage.htm”) to server 130 to access the data at the site specified in the URL. When server 130 receives a URL request, server 130 first locates the file (e.g., “homepage.htm”) referenced in the URL and then forwards the content of the file associated with the web page to client 110. The contents of a web page are currently created using a computer language called the Hypertext Markup Language (HTML). This content is stored as HTML files 140 on server 130. Other languages such as Extensible Markup Language (XML) and the like are also used for creating web pages.

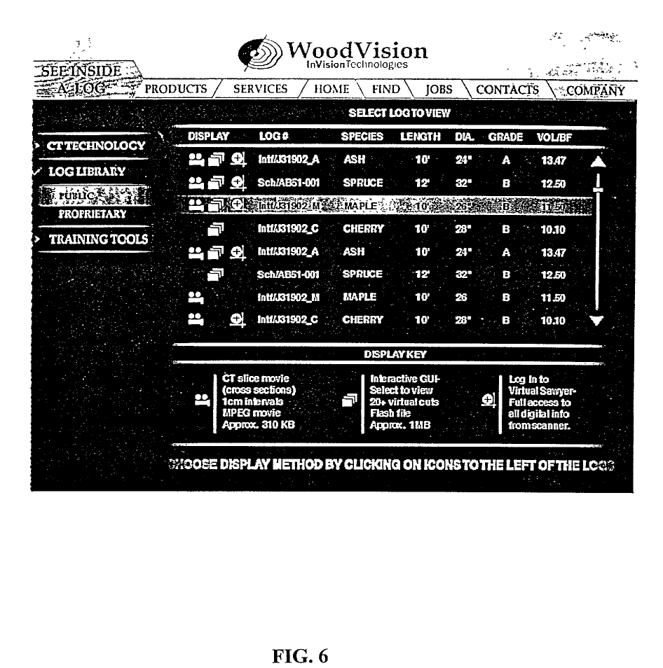

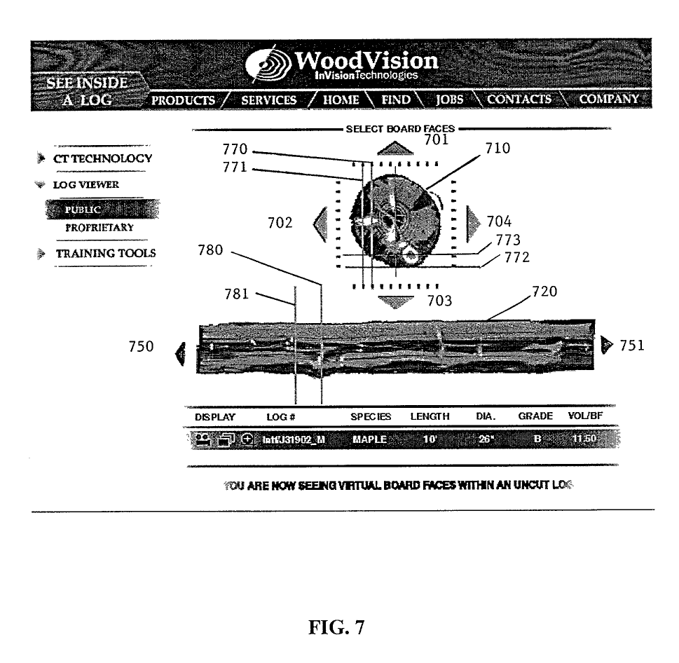

Browser 120 after receiving the HTML file from server 130 parses the HTML file and graphically displays a web page, such as that illustrated in FIG. 5, on client computer 110's display screen. The first page of a web site is referred to as the homepage. As shown, in embodiments of the system, the homepage includes a graphical user interface menu composed of multiple buttons. The homepage is linked by means of hypertexts or hyperlinks to other graphically displayable pages. FIGS. 6 and 7 illustrate examples of such pages. In alternative embodiments of the invention, alternative homepages to that illustrated in FIG. 5 may be implemented.

Hypertext or hyperlinks are used for maneuvering among the multiple pages of a web site. Buttons displayed as part of the interactive menu in FIG. 5 are typically associated with a hypertext or a hyperlink. Hypertexts and hyperlinks are predefined linkages between web pages and are displayed either as text or as an icon that can be activated by a user. Activating a hypertext or a hyperlink allows a user to browse a new web site or web page without having to enter the address or location (e.g., URL) of the new web site, or web page. To activate the link, a user uses a mouse to click on the hyperlink or hypertext, for example. A URL associated with the link identifies the location of the requested site or web page and displays a new web page on client computer 110's display screen.

Access to various features of the system is made possible through interaction with hyperlinks or hypertext included in the system's homepage. System features may also be available through other web pages, or sites that are affiliated with or linked to the system.

In embodiments of the system, to view a list of logs offered for sale on the system, the user can use the mouse or other user interface to select a button from a section of the web page labeled log library 510, for example. Clicking on button 520 entitled “Public” for example causes the system to display a web page that includes a list of logs that are available for sale and/or examination. This list is accessible by all system users. On the other hand, selecting the “Proprietary” button 530 provides a user with access to a proprietary list that is accessible to specific users.

The proprietary list, in some embodiments, is protected by a password, for example, to prevent an unauthorized user from viewing the content of the list. Using this feature, a log seller can limit access to information stored on the system about certain logs. For example, a log seller may want to give long-term or preferred customers advanced viewing options so that they can view additional information about a log. Further, the log seller may want to allow certain customers to view certain logs (e.g., better quality logs) in the inventory before others. Thus, the system is configured to provide a selected group of users with additional services or viewing options not immediately made available to all users.

For example, a log seller may want to provide a certain group of purchasers (e.g., first time users) with lower prices on certain logs so they will become long-term purchasers. Or a seller may want to provide a discount to those who purchase more than a certain number of logs. Thus, in embodiments of the system, before displaying the list of available logs, the system identifies a user based on his user ID, his purchase profile with the system, or other relevant factors. If the system determines that the user is eligible for a discount, then a list of logs at a discounted rate is displayed to the user.

Referring to FIGS. 4 and 5, selecting one of the buttons (e.g., “public” or “proprietary’) from the menu activates a hyperlink that causes a display of the web page containing a list of logs. At step 420, the user views the list of available logs. FIG. 6 illustrates an example of a web page, in accordance with one or more aspects of the invention that includes a list of logs available in a log database. The list includes information about the log's species (e.g., Maple, Spruce, Ash, etc.), length (e.g., 10 feet), diameter (e.g., 24 inches), volume per board feet (e.g., 11.50), and identification number. The price and grade of a log are also listed in certain embodiments.

A log's grade depends on the various log characteristics and certain factors taken into consideration as a whole. Some characteristics and factors that are determinative of the grade and value of a log are the log's grain pattern, color, shape, diameter, sweep, taper, growth pattern, and the section in the tree from which the log was cut. The number and nature of defects in a log and the position of the defects also affect a log's price and grade. Some or all the above characteristics and factors are discernable from scan data produced as the result of scanning the log. In embodiments of the invention, the system has access to the scan data for a selected log that has been previously scanned and calculates the grade of the log based on the scan data, or based on information entered by a user about the desired characteristics of the log.

Various grading systems available in the industry grade a log based on external log features. In embodiments of the invention, the system is configured to calculate the grade of a log based, in part, on the grading standards promulgated by established industry authorities such as National Hardwood Lumber Association (NHLA) or by proprietary standards of forest product companies such as the Weyerhaeuser Corporation. Using the information listed for each log and one or more grading standards, the system can determine a log's value and grade. Grading information is helpful to the users and allows them to estimate the value of the log independent from the value suggested by the system or the seller.

Grading information is especially helpful to purchasers who have special requirements. For example, a purchaser who has unique grain pattern or clear board face needs will be able to determine if these grade needs will be met by viewing or querying information available in the system. In addition to grade information, a purchaser can obtain further details about a log by utilizing additional features of the system that provide in-depth information or views of the log. As illustrated in FIG. 6, in embodiments of the system, a number of viewing options or display levels are available for each log. Depending on the different display levels available, one or more icons are displayed next to the description of the log. For example, three icons are displayed next to log number “Intf/J31902_M” indicating that three display levels are available for that log. As shown, only one icon is displayed next to log number “Intf/J31902_C” indicating that only one display level is available. The shape of the icons indicates which views are available.

An icon in shape of a movie camera, for example, indicates that a movie including images of various cross-sections of a log is available. The movie can be played on a user computer system utilizing the Microsoft Media Player®, or the Real Networks Real Player®. Another icon in shape of three overlapping rectangles, for example, indicates that images of selected cross-sections of the log are available for viewing. Using the interface tools on the system, a user is able to move from one image to the next or have a slideshow, for example. Yet, another icon in shape of a log placed on a scanner, for example, indicates that a user may access full scan information for that log to evaluate, analyze, and view the log. Thus, to view the presentations available at each level a user selects the icon associated with that level.

In some embodiments, to access the various display levels, a user at step 430 first selects the log from the log list displayed in FIG. 6 by clicking on the log's number, for example. Once the log is selected, the system loads a web page, such as the web page illustrated in FIG. 7, for example. The web page, in addition to displaying the previously listed information (e.g., length, diameter, grade, etc.) for the selected log, also displays additional visual information depicting various features of the log. For example, according to one embodiment of the system, selected face or side images of the log, or cross-sections thereof may be displayed. In some embodiments, the displayed images are of the external features of the log. In other embodiments, the images display selected cross-sections of the log, as illustrated in FIG. 7, including the internal features of the log. The displayed images are virtual images of the log reconstructed from scan data acquired from scanning the log.

In accordance with one aspect of the system, portions of the log are displayed in different shades of gray, transparencies, or colors to distinguish various features of the log. For example, voids may be displayed in lighter colors, while the more dense portions of the log (e.g., knots) are displayed in darker colors. As it is further described below, in embodiments of the system, a user can view internal features of the log by interacting with graphic user interfaces that allow the user to maneuver from one cross-sectional view to another. Certain embodiments of the invention include interactive tools such as arrow-shaped buttons, for example, that allow a user to cause the system to display images of various sections of the log. Referring to FIG. 7, in one embodiment, plurality of buttons are displayed in association with one or more images of the log. The images are views of virtual cross-sections of the log, in accordance to one or more embodiments, however, it can be an image of any other aspect of the log depending on implementation.

In one embodiment, the displayed cross-section lies in a first plane of reference that virtually slices the log. Clicking on one of the buttons (e.g., a button depicting an upward facing arrow) changes the displayed image to a view of another cross-section of the log in a plane other than the first plane of reference (e.g., a second plane virtually slicing the log in a different angle than the first plane). In some embodiments, clicking on the buttons causes the system to display successive cross-sectional views of the log, where selected cross-sections lie in equidistant parallel planes that virtually slice the log through the log's diameter, length, or height.

As illustrated in FIG. 7, in accordance with an aspect of the system, after a user selects the log at step 430, two cross-sectional views of the log are displayed, for example. One view is a virtual axial cross-section 710, in a first plane of reference. The first plane of reference is perpendicular to the log's longitudinal axis and virtually slices the log through the log's diameter. The second cross-sectional view is a virtual longitudinal cross-section 720, in a second plane of reference. The second plane of reference is parallel to the log's longitudinal axis and vertically slices the log in its length to produce a board face view.

In embodiments of the invention, one or more cross-sectional views of the log may be displayed. For example, in one embodiment, a third view of another longitudinal cross-section of the log in a third plane of reference may be displayed. The longitudinal cross-section in the third plane of reference may be either superimposed over one of the above two cross-sectional views when selected, or separately displayed, depending on system implementation. In one embodiment, the third plane of reference is parallel to the log's longitudinal axis and perpendicular to the second plane of reference and horizontally slices the log along its length, for example. The above-described planes of reference are provided by way of example. Other planes of reference may be implemented in alternate embodiments of the invention slicing the log in different manners or angles.

As shown, the first plane of reference is depicted in longitudinal cross-section 720 by a vertical line 780. The second and third planes of reference are depicted in axial cross-section 710 by vertical line 770 and horizontal line 773, receptively. Buttons depicting left and right facing arrows 750 and 751 are associated with axial cross-section 710 and the position of the first plane of reference along the length of the log depicted by vertical line 780. Clicking on buttons 750 and 751 advances the position of the first plane of reference (i.e., shown as line 780) through the length of the log in a direction towards or away from one end of the log. For example, clicking on left arrow 750 displaces the first plane of reference to a new position depicted by vertical line 781 towards the left end of the log.

Alternatively, clicking on right arrow 751 displaces the first plane of reference to a position (not shown) away from the left end of the log and towards the right end. Clicking on buttons 750 and 751 changes the displayed axial cross-section 710 to a new cross-sectional view of the log. The new cross-section lies in the first plane of reference after the plane's position is advanced to a new position through the length of the log as described above. For example, clicking on left arrow 750 causes the system to display an axial cross-sectional view of the log in the first plane of reference in the position depicted by vertical line 781.

Buttons 701 through 704 are associated with longitudinal cross-section 720 and the position of the second and third planes of reference along diameters of the log (i.e., depicted by vertical line 770 and horizontal line 772). Clicking on buttons 702 or 704 changes the position of the second plane of reference through the diameter of the log. For example, clicking on left facing arrow 702 displaces the position of the second plane of reference, shown as vertical line 770, to a new position depicted by vertical line 771. In association with the change in position of the second plane of reference, longitudinal cross-section 720 is updated to display a longitudinal cross-section of the log after the second plane of reference is displaced to a new position (e.g., depicted by vertical line 771). Similarly, clicking on buttons 701 and 703 changes the position of the third plane of reference, shown as horizontal line 772, to a new position (e.g., position depicted by horizontal line 773). As a result of the third plane's change of position, longitudinal cross-section 720 is updated to display another longitudinal cross-section associated with the third plane.

The cross-sectional views displayed in FIG. 7 are reconstructed from scan data acquired from scanning the specific log selected by the user. The scan data includes information about density distribution in the log. Images of each cross-section of the log are reconstructed based on scan data to show the internal features of the log. In accordance with an embodiment of this invention, the system provides a user with one or more different options to further view and learn about the internal characteristics of the log.

As discussed earlier, for example, in certain embodiments, at step 440, a user can choose to view images of multiple cross-sections of the log in movie format. Virtual views of successive axial cross-sections throughout the log are reconstructed based on the scan data for the log and are displayed in predetermined intervals. For example, axial cross-sectional views of the log are displayed in one-centimeter intervals as the plane of reference (i.e., the plane that includes the displayed cross-section) advances from the front end of the log towards the back end of the log. The movies can be digital movies that are played using the Real Network's Real Player®, or Microsoft's Media Player®, for example. Any other type of player may be used.

In another embodiment, cross-sectional longitudinal views of the log are displayed at one-centimeter intervals, for example, as the plane of reference virtually slices the log along the log's diameter in successive intervals. In some embodiments, displayed cross-sections lie in a plane that includes the log's longitudinal axis and the plane of reference moves in a rotational relationship with respect to the longitudinal axis, in one-degree intervals, for example.

At step 450, the user can choose to view pre-selected cross-sectional images of the log. Some presentations in addition to cross-sectional views also include three-dimensional perspective views of the log. The three-dimensional views can be either opaque showing the exterior surface of the log, or transparent displaying the interior features of the log as well. The presentation can also include views of the log from different angels and different slices in the log. The ability to view the log from different viewing perspectives and depths provides the user with adequate information to accurately evaluate a log.

At step 460, the user can choose to fully access all scan data available for the selected log. Using this feature, the user can cause the system to display images of the log from different angles or cross-sections as chosen by the user. For example, the user can cause the system to display a perspective view of a log from various angles, orientations, and depths. Further, the user can use system tools and features to rotate the log about different log axes so that different views of the log are produced. Having full access to scan data also allows the user to simulate virtual cuts in the log from many different perspectives. For example, the user can select to view a cross-section of the log that runs diagonally across the length of the log from one end to the other.

Further, the user can rotate the CT cross-sectional image in various orientations to produce virtual board face images viewed from various angles. The user can further adjust the orientation of the log to change the display angle of the log according to the taper of the log. In certain embodiments, various user-specified views are rendered in real time after scan data for the selected image is retrieved by the system. In other embodiments, certain views maybe pre-selected by the system, or certain images may be available for viewing instantly without the need to access all scan data for the log.

In embodiments of the invention, to fully access the scan data, the user needs to use special software that is available through the service provider. The service provider may limit access to this software to selected customers or users, who have purchased a log and need to access the information to determine a cut solution for the log. In some embodiments, the software may be downloaded from server system 130 to client computer 110. In other embodiments, the software may run on server system 130 and remotely service requests submitted by client computer 110. Other implementations are possible. For example, the software may be partially installed on both computer 110 and server 130.

The special software may also be utilized for training or evaluation purposes or in conjunction with the above viewing levels described. For example, in embodiments of the system, the user utilizes the special software to view images of the exterior of a log and to rotate the log and view it from different angles. The user then based on information gathered from viewing images of the log's exterior utilizes system tools to simulate a cut pattern on the log, using the mouse or other user interface devices. The user can specify, for example, the number, length, width, and thickness of boards that he wants to produce using a certain cut pattern. The system, using the scan data available for the log, evaluates the virtual boards produced from the cut pattern suggested by the user. The system then generates a report indicating the value, grade, quality, and measurements for each board produced. This information can be used for grading, optimization, and training purposes.

In addition to the above features, in some embodiments, the system also includes in the report information about the boards that would have been produced had the same log been sawed based on a system recommended cut pattern. A system recommended cut pattern is a sawing strategy determined by the system based on the scan data acquired from scanning the log. Because scan data includes information about the internal features of the log, the system can develop a sawing strategy that results in an optimal cut solution for that specific log. The system can also generate an optimal cut solution based on the user's input (e.g., board length, thickness, etc.).

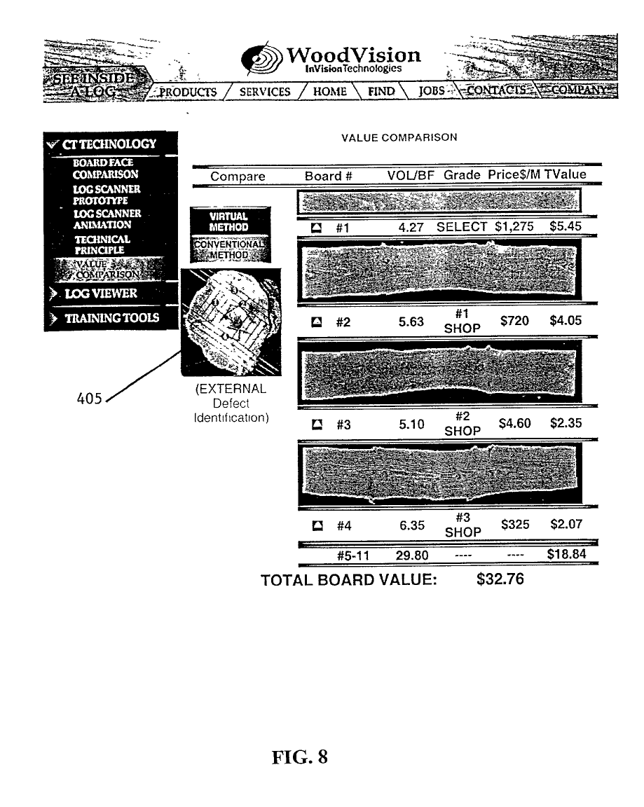

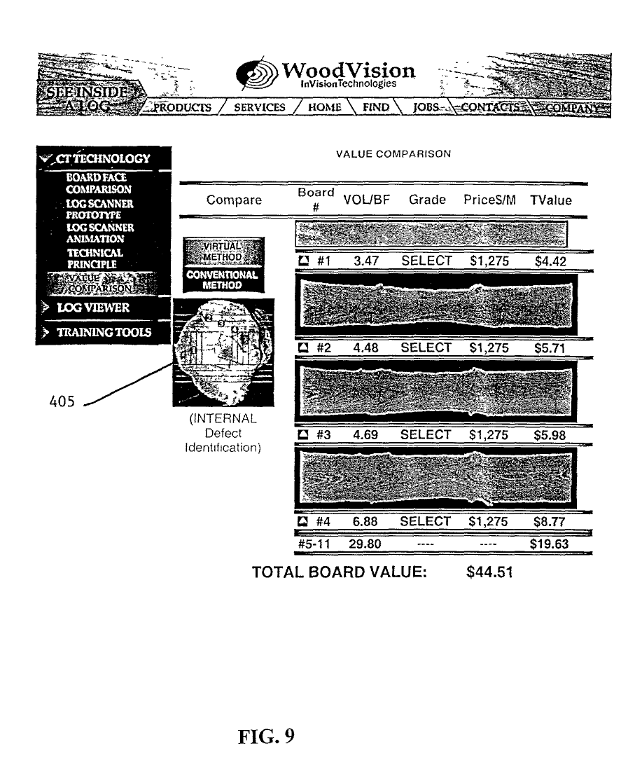

The following examples provide a better understanding of this feature of the invention. FIGS. 8 and 9 illustrate examples of different sawing strategies and virtual boards produced based on different cut patterns. FIG. 8 illustrates an example of virtual board faces in association with the number and value of boards that are produced by the system using a conventional sawing method (e.g., user suggested cut pattern). In accordance with one aspect of the invention, once the user selects a log, the system provides a user with a view of the outer surface of the log and the option to virtually cut the log or input certain information to define a cut solution for the log. A user then interacting with the system via user interface tools (e.g., mouse, keyboard, etc.) selects certain portions of log 405 for a specific cut pattern. As shown in FIG. 8, for example, the user may draw lines on an image of one end of the log, where each line defines a virtual plane (perpendicular to the displayed cross-section) that slices the log longitudinally.

In a log, the best quality wood is typically located half way between the core and the outer surface, where because of the natural growth pattern of a tree the possibility of occurrence of knots and decay is minimal. Thus, a user (e.g., sawyer) isolates the best portions of log 405 by selecting cut portions from the areas of the log that have the potential to generate the maximum number of good quality boards. FIG. 8 illustrates an example where log 405 has been virtually cut into four groups of boards. The cut solution identified by number one is an example of a log region with the highest quality wood (e.g., select grade). Other board groups identified by numbers two through four result in production of lower quality boards (e.g., #1 shop, #2 shop, and #3 shop). The system analyzes the sawing strategy based on scan data available for the selected log and determines the number and value of boards generated in each group as a result of application of such strategy to the specific log. In some embodiments, the system also displays examples of virtual board faces resulting from the cut solution suggested by the user.

As shown in the example illustrated in FIG. 8, using the user's sawing strategy, the area marked as section one in log 405, for example, produces 4.27 board feet of select grade boards at the value of $1,275 per board feet, for a total value of $5.45 per thousand board feet. Areas marked as sections two through four respectively produce 5.63, 5.10, and 6.35 board feet of various shop grade boards at values of $720, $460, and $325, for total values of $4.05, $2.35, and $2.07 per thousand board feet. The log sections that do not fall within sections one through four have a value of $2.07 per thousand board feet. Thus, the system calculates the total board value of $32.76 produced from log 405 based on the user's cutting solution.

Referring to FIG. 9, a user can also use the system to automatically generate an optimal cut solution for log 405 by choosing the virtual method option, for example. The system can access all scan data for log 405. Thus, by analyzing the scan data, the system can detect the undesirable portions of log 405 and use a special algorithm to determine the best cutting solution for log 405. As shown, using the system-suggested cut solution, the total value of boards is $44.51, in this example, a fairly noticeable increase over the value of $32.76 for the boards produced from the user suggested cut solution.

In alternative embodiments of the system, in addition to the above methods, a user may also select a cut solution by entering specific information about the number, type, and size of boards that the user desires. For example, a user may specify that a desired cut solution for log 405 is one that produces five, 12-foot, 10×4 boards of select grade. The system then evaluates the user request against the scan data for log 405 and generates a cut solution that satisfies the request. If the request cannot be satisfied then the system generates the closest solution that satisfies the specific user request. For example, if five, 12-foot, 10×4 boards cannot be produced the system may determine a cut solution that would produce three, 12-foot, 10×4 boards, or five, 10-foot, 10×4 boards.

A user can review the generated reports to determine which cut strategy produces the best results. By reviewing the report, a user can decide how to saw and process a log. By viewing the appearance of logs, selecting cut strategies, and reviewing system-determined board valuations, the user can improve his skill in determining the best-cut strategy for a log, based on the external features of the log. For example, a sawyer after training with these virtual training tools will improve his ability to determine an orientation for an appropriate sawing strategy. This training feature promotes the use of the system by presenting the user with practice tools and practical examples that can help the user make better decisions on how to produce better quality boards.

A user can utilize the above-described features of the system to evaluate or grade a log or a board by looking at views of the exterior of a log or a board. Using the system, the user can virtually rotate the log or the board for further evaluation. Alternatively, the user can access the scan data and view the internal features of a log or a board. Knowledge of the internal features in conjunction with a view of the external surface of a log can assist a user to improve his skills in evaluating and grading logs and choosing cut solutions that produce high quality boards, or high board values.

In certain embodiments, a user can cause the system to generate a grading or evaluation report for a selected log or board based on certain default parameters, such as length, diameter, grain pattern, and wood color. These default parameters may be modified to reflect the user's specific requirements or to comply with industry grading standards (e.g., standards developed by NHLA). In some embodiments, the system compares a user's evaluation of the board with the system's evaluation and generates a report based on that comparison. The report, for example, includes training tips for a user on how to evaluate and grade a board.

At step 470, after evaluating a log or a board using the services of the system, the user places an order or a bid. As noted earlier, depending on the business model implemented by the service provider, logs in the system database may be sold in an auction, reverse auction, or direct exchange. In some embodiments, the system may be used to transfer logs within a company, for example, the system can be used to transfer logs between high value wood mills to low value wood mills, or vice versa, based on system's evaluation of the quality of logs.

The financial transactions between log sellers and purchasers, and procedures for delivery and acceptance of logs are handled in manners that are well known in the industry. In embodiments of the system, a seller and purchaser that use the services of the system may be required to pay a fee for using the service. The fee may be commission based, paid on a per use basis, or in form of a periodic subscription fee.

In certain embodiments, the purchaser after receiving the log, can access the system to determine the best sawing strategy for the log by, for example, entering the log number into the system. The system can be configured to provide optimal cut solutions for the log purchased in a form that is downloadable over the Internet directly onto the sawing system utilized for cutting the log at the purchaser's premises. The log purchaser can use the services described above to re-evaluate a log's features and to determine a sawing strategy that best suits the needs of the purchaser.

Hardware Environment

An embodiment of the system that includes application and system software can be implemented as computer software in the form of computer readable code executed on a general purpose computing devices such as client computer 110 or server system 130 or both, as illustrated in FIGS. 1, 2A, and 2B. Computer 110 and server 130 may include a central processor unit (CPU) 201, a main memory 202, an input/output controller 203, optional cache memory 204, user interface devices 205 (e.g., keyboard, mouse, microphone, camera, etc.), storage media 206 (e.g., hard drive, flash memory, floppy, optical, or magneto-optical disks, etc.), a display screen 207, a communication interface 208 (e.g., a network card, a modem, or an integrated services digital network (ISDN) card, etc.), and a system synchronizer (e.g., a clock, not shown in FIG. 2A).

Processor 201 may or may not include cache memory 204 utilized for storing frequently accessed information. One or more input/output devices such as a printing or a scanning device may be included. A communication device, such as a bi-directional data bus 200, can be utilized to provide for means of communication between system components. Computer 110 and server 130 may be capable of communicating with other systems through communication interface 208.

In one or more embodiments, computer 110 or server 130 may not include all the above components, or may include additional components, to provide additional functionality or utility. For example, computer 110 can be a laptop computer or other portable computing device that can send messages and receive data through communication interface 208. The system hardware environment may also be embodied in the form of a set-top box, a personal data assistant (PDA), a wireless communication unit, or other similar hardware environments that have information processing and/or data storage and communication capabilities.

In embodiments of the system, communication interface 208 can send and receive electrical, electromagnetic, or optical signals that carry digital data streams representing various types of information. If communication is established via the Internet, server system 130 may transmit program code to client computer 110 through Internet connection 150. The program code is executed by central processor unit 201 or is stored in storage media 206 or other non-volatile storage for later execution.

Program code may be transmitted via a carrier wave or may be embodied in any other form of computer program product. A computer program product comprises a medium configured to store or transport computer readable code or a medium in which computer readable code may be embedded. Some examples of computer program products are CD-ROM disks, ROM cards, floppy disks, magnetic tapes, computer hard drives, and network server systems.

In one or more embodiments of the invention, processor 201 is a microprocessor manufactured by Motorola or a microprocessor manufactured by Intel, such as a Pentium processor, or a SPARC microprocessor from Sun Microsystems, Inc. The named processors are for the purpose of example only. Any other suitable microprocessor or microcomputer may be utilized.

Software Environment

FIG. 2B illustrates computer software 220 suited for managing and directing the operation of computer 110 or server system 130, for example. Software 220 is, typically, stored in storage media 206 and is loaded into memory 202 prior to execution. Software 220 includes an operating system (OS) 221 that controls the low-level operations of system 210. Low-level operations include the management of the system's resources such as memory allocation, file swapping, and other core computing tasks. In one or more embodiments of the invention, operating system 221 is Microsoft Windows 2000, Microsoft Windows NT, Macintosh OS, or IBM OS/2. However, any other suitable operating system may be utilized.

One or more computer programs, such as software application 222, are executed on top of the operating system 221 after loading from storage media 206 into memory 202. In client-server architecture, software application 222 may include client software 222(a) and server software 222(b). Referring to FIG. 1 for example, in one embodiment of the invention, client software 222(a) is executed on client computer 110 and server software 222(b) is executed on server system 130. Computer software 220 may include a web browser 223 for communicating with the Internet. Computer software 220 includes a user interface 224 (e.g., a Graphical User Interface (GUI)) for receiving user commands and data. The commands and data received are processed by the software applications that are running on the computer system 110.

Universal System Architecture

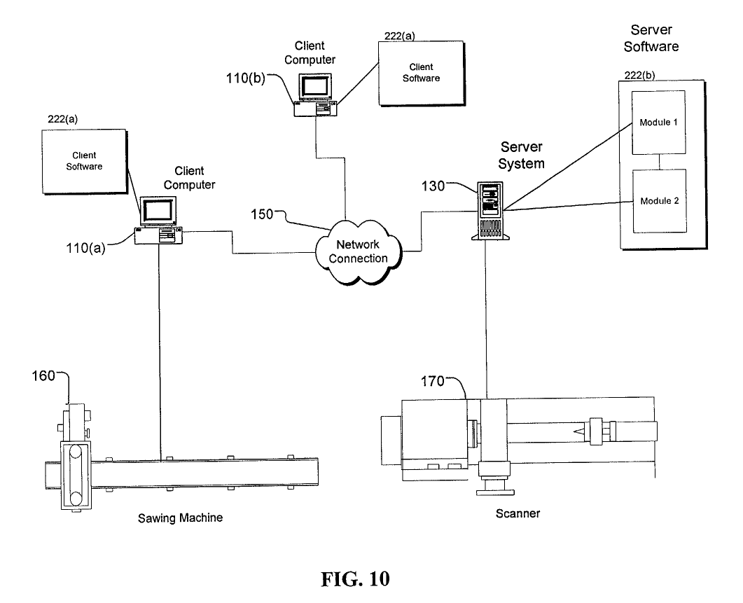

FIG. 10 illustrates a network architecture in accordance with one or more embodiments of the invention, wherein image data produced in different scan formats is reformatted into configurations that are recognizable and displayable by a client computing system attached to the network. The network architecture includes one or more client computers (e.g., computer 110(a), 110(b), etc.), at least one server system 130, and other peripherals such as a sawing machine 160 and scanner 170, attached in a computer network through network connection 150.

As described earlier, software application 222 runs partly on client computer 110(a) and server system 130. Part of software application 222 that runs on client computer 110(a), or other client computers attached to the network, is referred to as client software 222(a). Part of software application 222 that runs on server system 130 is referred to as server software 222(b). Client software 222(a) communicates with server software 222(b) by submitting requests to access the services provided on server system 130. Server software 222(b) services the submitted requests.

Server software 222(b), in accordance with one aspect of the system, manages and/or has access to one or more databases that contain information (e.g., scan data, image files, cut solutions) about scanned logs available on the system. Server software 222(b) receives a request from client software 222(a) for access to certain information stored in the one or more databases. Server software 222(b) searches the one or more databases, finds the information requested, and processes the information to provide the appropriate response to client 110(a)'s request.

In embodiments of the invention, image data about a log is stored in the one or more databases. Typically, image data is produced by a scanning system such as scanner 170. Scanner 170 is connected either directly to server system 130 or to a computing system (not shown) that communicates with server system 130 through network connection 150. In a certain embodiment of the invention, multiple scanners are connected to the system via network connection 150. Scan data from scanner 170 is, typically, voluminous and includes information about many features of a scanned log through out the entire length of the log. Therefore, scan data, prior to transmission to server system 130, is compressed to allow the data to be transferred in less time. In embodiments of the invention, scan data can also be encrypted for security purposes before transmission. Client software 222(a) or other software running on the computing system that works in conjunction with scanner 170 can handle the compressing and encrypting.

In accordance with one aspect of the invention, server software 222(b) includes one or more computer programs or modules, such as modules 1 and 2, implemented to filter, reconfigure, and prepare image data for delivery to one or more client systems. Module 1, for example, is implemented to interpret a client's request to access image data and to filter image data in accordance with client specific instructions included in the request. Module 2, for example, is implemented to configure image data so that the data is compatible with the requirements and/or limitations of the requesting client's computer system. Modules 1 and 2 as discussed herein may be implemented in one or more computer programs. Further, modules 1 and 2 may run in whole or in part on one or more client computers or server systems, depending on system implementation.

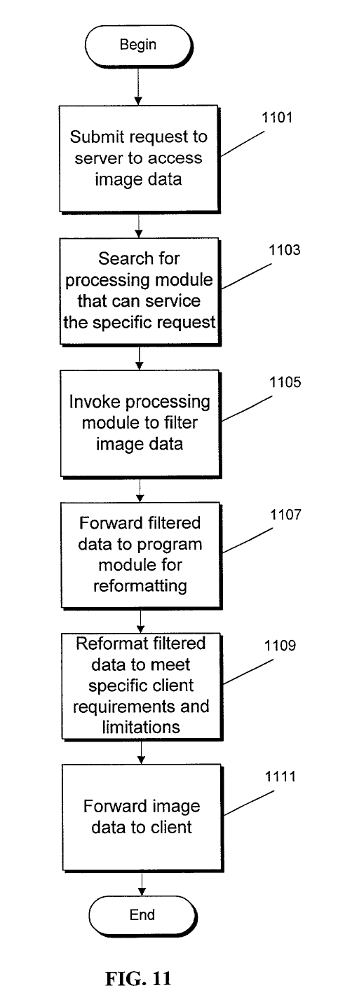

FIG. 11 illustrates a flow diagram for a method of formatting and transmitting requested image data from a server system to a client computer, in accordance with one embodiment of the invention. At step 1101, client 110(a) submits a request to server 130 to access scan data available on the system for a certain log. Each log is identified by number, for example. In certain embodiments, the client can request access to complete scan data for a log by referencing the log's identification number. However, a client may not need to access or retrieve all of the scan data for a log. Retrieving all of the scan data for a log may be unnecessary depending on the particular information needed to satisfy a client request and/or requirements and limitations of the client computer. Furthermore, processing and transmitting complete scan data for a log can be highly time and resource intensive.

Accordingly, a client request in addition to including identifying information for a certain log includes a data model that defines specific boundaries for the type and amount of scan data needed to display certain images of the log. Certain sections of scan data may be associated with a certain type of defect in the log. Further, specific identifiable sections of scan data can be reconstructed into images of one or more cross-sections of a log. As such, a data model included in a request provides the system with instructions that identify specific sections within scan data that need to be filtered out to satisfy a client's request for information related to specific sections of the log.

For example, a user may be interested in viewing only a certain type of defect (e.g., voids) and only a limited number of images (e.g., 7 cross-sectional views) in a log. Transmitting all scan data for the particular log would be inefficient when the relevant portions of scan data associated with the specific log sections can satisfy the user's request. As such, in embodiments of the invention, a client request includes boundaries that define the specific type of defects and the exact cross-sections within the log that the user is interested in viewing. For example, the data model can include coordinates along the log from which scan data is to be retrieved or other identifying information that pinpoint an area of interest.

An exemplary client request may include the following identifying information or fields: Scan ID, Source ID, Time, Job ID, Model Type, Number of Features, and Feature Type. Scan ID identifies the specific client request. Source ID identifies the scanner or the format that was used to produce the scan data for the desired log. Time refers to the system time when the client request was generated. Job ID identifies the job site that generated the request. Model Type and Feature Type identify the specific portion of scan data that needs to be retrieved. Each field in the data model provides the system with information on how to process the client request and the scan data associated with that request.

At step 1103, when server 130 receives client 110(a)'s request, server 130 searches for a processing module that can service the specific request according to information defined in the request. Depending on the type of features and number of cross-sections that a user would like to view, various data models may be implemented. Each data model may require a specific processing module that can process the particular format in which that data model is created. Thus, in embodiments of the invention, the requesting client is provided with the processing module for each data model. This processing module in some embodiments is implemented or installed on server 130 to service client 110(a)'s requests. In alternative embodiments, the processing module may be software locally installed and executing on client 110(a) or software remotely downloaded from server 130.

At step 1105, server 130 determines that, for example, module 1 is the proper module for servicing the submitted request. Thereafter, server 130 invokes module 1 to handle the task of filtering scan data for the specific log in accordance with specifications included in the data model. Module 1 processes scan data to retrieve only data that is necessary to satisfy the client's request as specified therein. In one embodiment, the client request includes information defining the type of scanner used to create the scan data. Based on this information the processing module can analyze scan data created in the specific scanning format. As such, scan data created by various scanning systems can be accessed by a client system, as long as the processing module recognizes and processes the specific scanning format.

In accordance with one aspect of the invention, a client request also includes information about special client requirements and limitations. To comply with these requirements and limitations the filtered image data produced by module 1 may need to be reformatted. Accordingly, at step 1107, program module 1, after filtering scan data, forwards the results to program module 2 for reformatting. At step 1109, module 2 reformats filtered data to meet specific client requirements and limitations. Module 2, for example, may compress filtered data or determine the best mode of transmitting data over network lines so that the client can display images at the highest resolution possible. After module 2 has reconfigured the image data, based on client 110(a)'s requirements, then the image data is forwarded to client 110(a), at step 1111.

In embodiments of the invention, data forwarded to client 110(a) can also include information about optimal cut solutions for the selected log. Sawing machine 160 can use this information along with other relevant information to cut the log in accordance with the provided cut solutions.

In certain embodiments of the invention, CT scanning and image reconstruction systems and methods are utilized to scan an object, produce scan data, and reconstruct scan data into virtual images of the scanned object. One or more of such embodiments are described in U.S. patent applications entitled “LOG EVALUATION USING CYLINDRICAL PROJECTIONS,” filed on Feb. 23, 2001, Ser. No. 09/792,650 (Attorney Docket No. M-8681 US), and “ANALYSIS AND PRESENTATION OF INTERNAL FEATURES OF LOGS,” filed on May 9, 2001, Ser. No. 09/851,840 (Attorney Docket No. M-8682 US). The content of the above applications is incorporated by reference, herein, in entirely.

The system architectures and environments disclosed herein are described by way of example. Embodiments of the invention may be implemented in any type of system architecture or processing environment. Thus, an on-line model for marketing and evaluating objects is described in conjunction with one or more specific embodiments. The invention is defined by the claims and their full scope of equivalents.

What is claimed is:

1. A method for marketing a log, the method comprising:
accessing scan information for a log, the scan information including information about internal features of the log;
processing the scan information to produce a marketing presentation; and
displaying the marketing presentation, wherein the marketing presentation includes one or more images reconstructed from the scan information, the one or more images displaying one or more internal features of the log.

2. The method of claim 1, wherein at least one of the images represents a cross-section of the log.

3. The method of claim 1, wherein at least one of the images provides a perspective view of the log.

4. The method of claim 1, wherein the marketing presentation includes a movie including images of successive virtual cross-sections of the log in an axial direction.

5. The method of claim 1, further comprising analyzing scan data to determine a first strategy for sawing the log into one or more boards so as to maximize an aggregated value of the one or more boards.

6. The method of claim 5, further comprising:
analyzing a second strategy for sawing the log into one or more boards; and
comparing an aggregated value of the one or more boards produced as a result of the first strategy with the aggregated value of the one or more boards produced as a result of the second strategy.

7. The method of claim 6, further comprising reporting the difference between the results of the first and second strategies.

8. The method of claim 1, further comprising evaluating the log based on the internal features of the log as ascertainable from the scan information.

9. The method of claim 8, further comprising offering the log for sale.

10. The method of claim 1, wherein the scan information is produced by computer tomography.

11. A system for marketing logs, the system comprising:
a processor for executing code; and
code executed by the processor configured to market logs, the code comprising:
a method accessing scan information for a log, the scan information including information about internal features of the log;
a method processing the scan information to produce a marketing presentation that illustrates the internal features; and
a method displaying the marketing presentation.

12. The method of claim 11, wherein the marketing presentation includes:
a movie including images representing successive cross-sections of the log in an axial direction; and
one or more images of the log, the one or more images displaying internal features of the log; wherein:
at least one of the images represents a cross-section of the log and is produced from the scan information; and
at least one of the images provides a perspective view of the log.

13. The system of claim 11, wherein the code further comprises a method analyzing the scan information to determine a first strategy for sawing the log into one or more boards to maximize an aggregated value of the one or more boards.

14. The system of claim 13, wherein the code further comprises:
a method evaluating the one or more boards corresponding to the first strategy; and
a method displaying one or more board faces for the one or more boards corresponding to the first strategy.

15. The system of claim 13, wherein the code further comprises:
a method analyzing a second strategy for sawing the log into one or more boards; and
a method comparing the aggregated value of the one or more boards corresponding to the first strategy with an aggregated value of the one or more boards corresponding to the second strategy.

16. The system of claim 15, wherein the code further comprises a method reporting a difference between results of the first and second strategies.

17. The system of claim 15, wherein the second strategy is user defined.

18. The system of claim 11, wherein the code further comprises a method for controlling the marketing presentation, wherein a user can interact with the system to cause the system to display virtual images of various cross-sections of the log.

19. The system of claim 11, wherein the code further comprises a method for controlling the marketing presentation, wherein a user can interact with the system to cause the system to display virtual images of various perspective views of the log.

20. The system of claim 11, wherein the marketing presentation comprises a pre-constructed image representing internal structure of the log.

21. The system of claim 11, wherein the method processing the scan information to produce a marketing presentation comprises constructing images of the internal features of the log, in real time as selected by the user.

22. A method of evaluating a log, using a computing system, comprising:
selecting a log from a log list displayed by the system;
in response to the selection, displaying an image of at least one cross-section of the log including information about internal features of the log, wherein the information is based on scan data for the log;
selecting a cut solution for the log based on the internal features included in the at least one cross-section, the cut solution defining a method for sawing the log into one or more boards;
displaying images representing one or more board faces for the boards corresponding to the selected cut solution; and
evaluating the boards corresponding to the cut solution and the scan data for the log.

23. The method of claim 22, further comprising assigning a price to the boards based on the evaluation.

24. The method of claim 22, further comprising assigning a grade to the boards based on the evaluation.

25. The method of claim 22, wherein the log list includes information about the grade of the log, the grade being calculated based on the scan data for the log.

26. The method of claim 22, wherein the log list includes information about dimension of the log, the dimensions being calculated based on the scan data for the log.

27. The method of claim 22, wherein the log is associated with a marketing presentation including a digital movie showing a plurality of cross-sections of the log projecting the internal features of the log.

28. The method of claim 22, wherein the log is associated with a marketing presentation including one or more images of pre-selected cross-sections of the log, a user interacting with a computer system to view the images.

29. The method of claim 22, wherein the log is associated with the scan data for the log, and a user interacts with a computer system to view various images of the log, the images being reconstructed from the CT scan data in real time.

30. The method of claim 22, wherein the selected cut solution for the log is determined by the computer system to maximize the aggregated value of the boards.

31. The method of claim 22, wherein a user provides the selected cut solution.

32. A method of displaying a log for sale on a system having a display device, and a processor for executing code embodied in a computer readable medium, wherein in executing the computer readable code the processor causes the system to perform acts comprising:
reconstructing scan data for a log to display a first axial view of a cross-section of the log on the display device, wherein the axial view lies in a first axial plane virtually slicing the log in a first position along the log's axis; and
in response to user interaction with the system, displaying a second axial view constructed from the scan data for the log to represent a cross-section of the log, wherein the axial view lies in a second axial plane through the log at a second position along the log's axis.

33. The method of claim 32, wherein a user can interact with the system to shift the position of the second axial plane along the length of the log.

34. The method of claim 32, wherein the first and second axial planes are substantially perpendicular to the log's axis.

35. The method claim 33, wherein in executing the code, the processor causes the system to further perform acts comprising:
constructing from scan data for the log, a longitudinal view of a cross-section of the log on the display device, wherein the axial view lies in a first longitudinal plane through the log at a first position along the log's diameter and a line crossing the longitudinal view represents the position of the first axial plane.

36. The method of claim 35, wherein in response to user interaction with the system, the line crossing the longitudinal view shifts to cross the longitudinal view in a second position that represents the position of the second axial plane along the log's axis.

37. A method of displaying a log for sale on a system having a display device, and a processor for executing computer readable code embodied in a computer readable medium, wherein in executing the computer readable code the processor causes the system to perform acts comprising:
constructing from scan data for a log a first longitudinal view representing a first cross-section of a log, wherein the first cross-section lies in a first longitudinal plane through the log at a first position along the log's diameter; and
in response to user interaction with the system, constructing from the scan data for the log a second longitudinal view of a second cross-section of the log, wherein the second cross-section lies in a second longitudinal plane through the log at a second position along the log's diameter.

38. The method of claim 37, wherein a user can interact with the system to shift the second longitudinal plane along the diameter of the log.

39. The method of claim 37, wherein the first and second longitudinal planes are substantially parallel to the log's axis.

40. The method claim 38, wherein in executing the code the processor causes the system to further perform acts comprising constructing from the scan data for the log an axial view of a third cross-section of the log, wherein the third cross-section lies in a first axial plane through the log at a first position along the log's length, and a line crossing the axial view represents the position of the first longitudinal plane.

41. The method of claim 40, wherein in response to user interaction with the system, the line crossing the axial view shifts to cross the first axial view at a second position, representing the position of the second longitudinal plane along the log's diameter.

42. A communication method for transmitting image information for an object comprising:
receiving a request for image information for an object, the request comprising:
information identifying scan data for the object;
information identifying scan format of the scan data;
information identifying portions of the scan data that are associated with one or more cross-sections of the object;
information identifying scan data associated with one or more internal features of the object; and
information identifying display limitations associated with a display system;
identifying the scan data based on the identifying information;
reading the scan data according to the format defined in the request;
filtering the scan data to produce image data associated with one or more cross-sections identified in the request; and
formatting image data to meet the display limitations identified in the request.

43. The communication method of claim 41, wherein the request further comprises information identifying limitations associated with communicating with the display system.

44. The communication method of claim 43, further comprising:
communicating image data to the display system at a rate to meet the communication limitations identified in the request.

45. A method of evaluating a log based on scan data available for the log, comprising:
processing scan data to identify various types of defects in the log;
processing the scan data to determine locations of the defects in the log;
processing the scan data to determine a density of defects per unit volume of the log; and
assigning a grade to the log based on the types, the locations, and the density of the defects.

46. The method of claim 45, wherein the grade is determined by standards provided by the user, wherein the standards define the grade based on the types, the locations, and the density of the defects.

47. The method of claim 46, further comprising:
receiving a grade;
searching a database storing grades assigned to one or more logs for a log that matches the grade.

48. A method of selling one or more logs based on scan data available for the logs, comprising:
processing scan data to identify various types of defects in one or more logs;
processing the scan data to identify locations of the defects in said one or more logs;
receiving a request for lumber including specific dimensions; and
selecting from said one or more logs, a log that in consideration of the identified defect types and locations can be cut to produce lumber of approximately the same dimensions specified in the request.
